(19) United States
(12) Patent Application Publication
(10) Pub. No.: US 2008/0232114 A1
(43) Pub. Date: Sep. 25, 2008

(54) Luminaire

(75) Inventors: Nynke Anne Martine Verhaegh, Eindhoven (NL); Bas Van Der Heijden, Eindhoven (NL); Maarten De Leuw, Eindhoven (NL); Gabrielle Johanna Bernarda Maria Meekes, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,418

(22) PCT Filed: Jan. 18, 2005
(86) PCT No.: PCT/IB2005/050201

§ 371 Date: Jul. 25, 2006

(30) Foreign Application Priority Data
Jan. 28, 2004 (EP) 04100291.6

(51) Int. Cl. F21V 7/22

(52) U.S. Cl. 362/341

(57) ABSTRACT

A luminaire has a reflector body (9) with a reflecting portion (2) provided with a coating (5) based on an inorganic sol-gel system, preferably a silica-based sol-gel system. The coating comprises a light-transmitting binder. The light-transmitting binder comprises light-reflecting particles. The light-reflecting particles are chosen from a group formed by titanium oxide, aluminum oxide, halophosphates, calcium pyrophosphate, and strontium pyrophosphate. The light-reflecting particles are surrounded by a skin layer for improving the reflection of the coating. Preferably, the skin layer comprises silicon oxide or aluminum oxide. Preferably, the light-transmitting binder comprises silicon oxide particles.

The invention relates to a luminaire comprising a reflector body with a reflecting portion provided with a coating.

Luminaires of the kind mentioned in the opening paragraph are used inter alia in ceiling lighting and for illuminating objects such as, for example, objects in a shop window, in a shop, in an exhibition space, for example for the illumination of art objects, or in a showroom, for example for the illumination of comparatively large objects, for example vehicles. Such a luminaire is further used for wall illumination so as to illuminate objects from the side, or as floor illumination, for example on theatrical stages, for the illumination of objects or persons. Said luminaire is also employed in outdoor environments. Said luminaire is further used as a backlight for, for example, (picture) display devices such as, for example, (plasma addressed) liquid crystal displays, or video walls, and as office lighting, or as a luminaire for enhancing the appearance of an object.

International Patent Application WO-A 01/75358 describes a luminaire with a molded reflector body comprising a reflective coating with light-reflecting particles and a binder and having a reflecting side portion and an outer surface. The coating has a smooth optical waveguiding surface due to the absence of particles at its outer surface and to the light-transmission properties of the binder. Owing to these properties, the coating has a high degree of specular reflection, thereby both increasing the lumen output ratio and improving the light-directing properties of the luminaire.

A drawback of the known luminaire is that the coating is sensitive to degradation reducing the lifetime of the luminaires.

The invention has for its object to eliminate the above disadvantage wholly or partly. According to the invention, a luminaire of the kind mentioned in the opening paragraph for this purpose comprises:

a reflector body with a reflecting portion provided with a coating based on an inorganic sol-gel system,

the coating comprising a light-transmitting binder,

the light-transmitting binder comprising light-reflecting particles,

the light-reflecting particles being chosen from a group formed by titanium oxide, aluminum oxide, halophosphates, calcium pyrophosphate, and strontium pyrophosphate, and

the light-reflecting particles being surrounded by a skin layer for improving the reflection of the coating.

The sensitivity of the coating to UV exposure to high temperatures is reducedin that the coating is based on an inorganic sol-gel system. As a consequence the sensitivity of the luminaire provided with such a coating is reduced, extending the lifetime of the luminaire according to the invention. The coating is based on an organic system in the known luminaire. In particular, the light-reflecting particles in the known luminaire are combined with a light-transmitting binder, said binder being a silicone binder, a fluoro-polymer, or an acrylate. The measure according to the invention is notably suitable for outdoor luminaires.

The inorganic sol-gel process is a versatile solution process for making ceramic and glass materials. In general, the sol-gel process involves the transition of a system from a liquid “sol” (mostly colloidal) into a solid “gel” phase. With the sol-gel process, it is possible to fabricate ceramic or glass materials in a wide variety of forms: ultra-fine or spherical shaped powders, thin-film coatings, ceramic fibers, micro-porous inorganic membranes, monolithic ceramics and glasses, or extremely porous aerogel materials.

The starting materials used in the preparation of the “sol” are usually inorganic metal salts or organometallic compounds such as metal alkoxides. In a typical sol-gel process, the precursor is subjected to a series of hydrolysis and polymerization reactions to form a colloidal suspension or “sol”. Further processing of the “sol” enables one to make ceramic materials in different forms. Thin films can be produced on a piece of reflecting material by spin-coating or dip-coating. When the “sol” is cast into a mold, a wet “gel” will form. With further drying and heat-treatment, the “gel” is converted into dense ceramic or glass articles.

The binder, which transmits visible light, forms a transparent, light-guiding layer over the light-reflecting particles and over the reflector body. Diffuse and specular reflection of visible light occurs at the coating. The relatively high degree of specular reflection enables substantially all light originating from a light source to issue from the luminaire to the exterior directly or after only one reflection. This results in relatively low light losses owing to reflection against the coating. The luminaire according to the invention has a comparatively high light output ratio. The luminaire according to the invention is suitable for use in accent lighting because of its coating having a high degree of specular reflection.

Light-reflecting particles chosen from the group formed by titanium oxide, aluminum oxide, halophosphates, calcium pyrophosphate, and strontium pyrophosphate are very suitable for the coating. These light-reflecting particles can be very well combined with the light-transmitting binder, for example a silicone binder, a fluoropolymer (for example THV 200), or acrylate. A luminaire provided with a coating having such a composition of particles and binder on its reflector portion has very good light-reflecting and beam-shaping properties. Preferably, the size of the light-reflecting particles ranges from 100 to 500 nm.

Surrounding the light-reflecting particles with a skin layer causes a further improvement in the specular reflection of the coating. To improve the specular reflection still further, the skin layer and the light-reflecting particles preferably have different refractive indices. Preferably, the skin layer comprises silicon oxide or aluminum oxide. SiO₂ and Al₂O₃ are suitable materials for use as skin layer surrounding the light-reflecting particles.

In a preferred embodiment of the luminaire, the inorganic sol-gel system is a silica-based sol-gel system. The application of silica sol-gel systems is well known in the art Suitable starting materials in silica sol-gel systems are methyltrimethoxysilane (MTMS) and tetraethylorthosilicate (TEOS).

Preferably, the light-transmitting binder comprises silicon oxide particles. Adding silicon oxide particles to the light-transmitting binder renders it possible to make relatively thick coatings. By way of example, so-called Ludox™ particles (colloidal silica particles) may be employed. Preferably, the size of the silicon oxide particles ranges from 10 to 50 nm.

Relatively thick coatings can be realized, with the coating system used in the luminaire according to the invention. A preferred embodiment of the high-pressure discharge lamp assembly is characterized in that the thickness of the coating ranges from 1 to 200 μm. Preferably, the thickness of the coating ranges from 10 to 100 μm. Such a thickness cannot be realized in a luminaire based on organic coatings, like the known luminaire.

Metal is a very suitable material for the reflecting portion of the reflector body. Preferably, the metal comprises aluminum. The combination of an aluminum reflecting portion with a light-transmitting binder comprising silicon oxide particles is very suitable because of the match between their thermal expansion coefficients

In a preferred embodiment of the luminaire, the light-transmitting binder comprises a stabilizing agent. Such a stabilizing agent improves the stability of the coating.

These and other aspects of the invention are apparent from and will be elucidated with reference to the embodiments described hereinafter.

In the drawings:

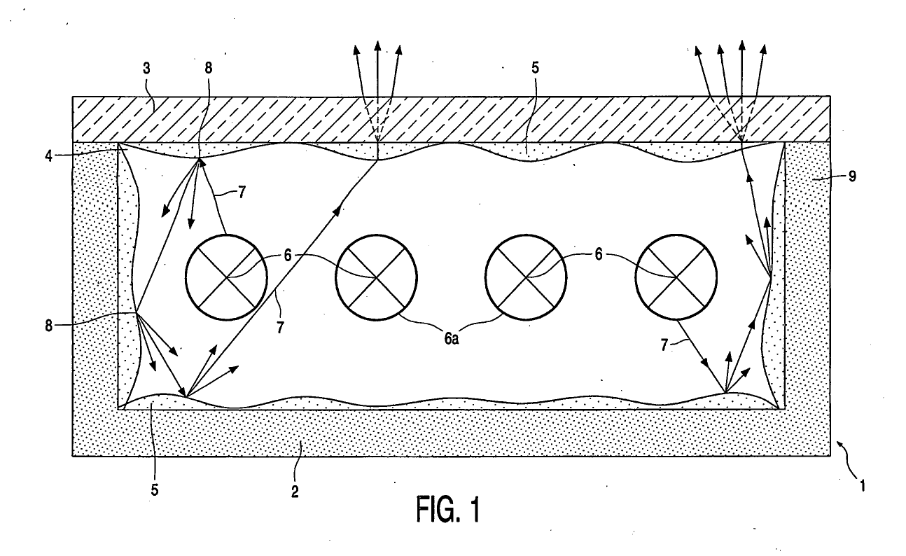

FIG. 1 shows an embodiment of a luminaire according to the invention in cross-section, and

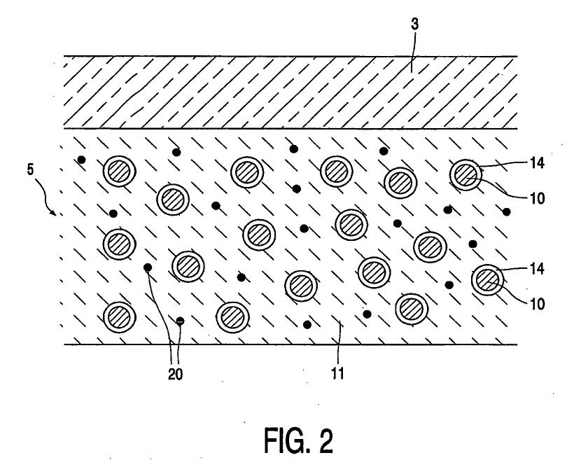

FIG. 2 shows a detail of the coating for a luminaire according to the invention.

The Figures are purely diagrammatic and not drawn to scale. Notably, some dimensions are shown in a strongly exaggerated form for the sake of clarity. Similar components in the Figures are denoted as much as possible by the same reference numerals.

FIG. 1 schematically shows an embodiment of a luminaire according to the invention in cross-section. The luminaire comprises a reflector body 9 with a reflecting portion 2. Preferably, the reflecting portion 2 of the reflector body 9 comprises a metal. In a favorable embodiment, the metal comprises aluminum. The reflector body 9 is provided with a coating 5 based on an inorganic sol-gel system. Preferably, the inorganic sol-gel system is a silica-based sol-gel system.

In the example of FIG. 1, the luminaire further comprises a diffuser 3 which is positioned in front of a light emission window 4 of the luminaire 1. In addition, the reflective portion 2 and the diffuser 3 are both coated with the coating 5. In an alternative embodiment, the coating 5 may alternatively be provided solely on the reflective portion 2. In FIG. 1, the luminaire 1 is provided with contact means 6. In addition, FIG. 1 shows by way of example four (tubular) low-pressure mercury discharge fluorescent lamps 6a accommodated in the contact means 6, for example PLS 11W. Other suitable lamps are high-pressure discharge lamps, such as a CDM or a SON. The lamps 6a are positioned in a longitudinal direction perpendicular to the plane of the drawing and along the light emission window 4. During operation of the lamps 6a, light beams 7 originating from the lamps 6a fall upon the coating 5 and are either reflected by the coating 5 or transmitted through the coating 5 and the diffuser 3. Each reflection 8 of the light beams 7 at the coating 5 causes some scattering of the light beams 7, eventually resulting in a homogeneous distribution of light. A final scattering of the light beams 7 takes place upon transmission of the light beams 7 through the diffuser 3. The result is that an object is illuminated homogeneously by the luminaire 1.

FIG. 2 schematically shows a detail of the coating for a luminaire according to the invention. The coating 5 comprises a light-transmitting binder 11. Preferably, the light-transmitting binder 11 comprises a stabilizing agent The light-transmitting binder 11 comprises light-reflecting particles 10. The light-reflecting particles 10 are chosen from a group formed by titanium oxide, aluminum oxide, halophosphates, calcium pyrophosphate, and strontium pyrophosphate. Preferably, the size of the light-reflecting particles 10 is in the range from 100 to 500 nm.

In FIG. 2, the light-reflecting particles 10 are surrounded by a skin layer 14 for improving the reflection of the coating 5. Preferably, the skin layer 14 comprises silicon oxide or aluminum oxide. In addition, the light-transmitting binder 11 further comprises silicon oxide particles 20. Preferably, the size of the silicon oxide particles 20 is in the range from 10 to 50 nm.

The thickness of the coating 5 is in the range from 1 to 200 μm. Preferably, the thickness of the coating 5 is in the range from 10 to 100 μm.

Basing the coating on an inorganic sol-gel system reduces the sensitivity of the coating to UV exposure and to high temperatures. As a consequence, the sensitivity of the luminaire provided with such a coating is reduced, extending the lifetime of the luminaire according to the invention.

A typical example of a luminaire coating suitable for use at high temperatures and resistant to UV exposure is a coating obtained from a silica-based sol-gel system, starting with methyltrimethoxysilane (MTMS) in combination with colloidal silica particles, for example Ludox™-50. The light-reflecting particles comprise either titanium oxide (TiO₂) or aluminum oxide (Al₂O₃) to improve the reflection of the coating.

Coatings based on MTMS/Ludox are very suitable, because the thermal expansion coefficient a matches that of the aluminum substrates in the luminaires (α_{MTMS/Ludox}=20 ppm/K and α_{Al}=24 ppm/K). This match in thermal expansion coefficient renders the manufacture of sufficiently thick coatings possible. A thick coating provides a relatively high total reflection. The silica-based sol-gel system coating, in the luminaire according to the invention is temperature-resistant up to 400-450° C., whereas the coatings cannot be used above 150° C. in the known luminaire based on an organic binder system. In addition, the silica-based sol-gel system coating in the luminaire according to the invention withstands UV-A and UV-B radiation to a high degree. Degradation of methyl groups by the photo-catalytic activity of TiO₂ particles is largely prevented in that TiO₂ particles are provided with a skin layer of SiO₂.

A coating in a luminaire based on an inorganic silica-based sol-gel system according to the invention is compared with a coating in the known luminaire based on an organic binder system. The reflectance at 550 nm is measured as a function of time when the coating is exposed to UV-B radiation (approximately 0.6 W/m²/nm; temperature=70° C.). In addition, the color change ΔE is measured as a function of time when the coating is exposed to UV-B radiation. The color change ΔE represents the influence of the various color components and is defined as follows:

ΔE=\sqrt{(ΔL)²+(Δa)²+(Δb)²},

where ΔL is the balance between black and white (if ΔL>0, then more whitish), Δa is the balance between green and red (if Δa>0, then more reddish), and Δb is the balance between blue and yellow (if Δb>0, then more yellowish).

Table I summarizes the results of the degradation as a function of time.

TABLE I
Degradation of the reflectance and color change ΔE as a function of
time for coatings exposed to UV-B radiation

| | coating in a | | | |
|---|---|---|---|---|
| | luminaire according | | coating in the | |
| | to the invention based on | | known luminaire | |
| | an inorganic silica-based | | based on an organic | |
| hours | sol-gel system | | binder system | |
| UV-B | | color change | | color change |
| radation | reflectance | ΔE | reflectance | ΔE |
| 0 | 96.5 | 0 | 95.9 | 0 |
| 100 | 96.5 | 0.08 | 95.9 | 0.15 |
| 200 | 96.5 | 0.10 | 95.7 | 0.28 |
| 400 | 96.4 | 0.11 | 94.2 | 0.68 |
| 1000 | 95.8 | 0.13 | 92.0 | 1.2 |
| 2000 | 95.1 | 0.17 | 89.9 | 2.6 |

Table 1 shows that coatings based on inorganic silica-based sol-gel systems in luminaires according to the invention are highly resistant to UV-radiation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A luminaire comprising:
a reflector body (9) with a reflecting portion (2) provided with a coating (5) based on an inorganic sol-gel system,
the coating (5) comprising a light-transmitting binder (11),
the light-transmitting binder (11) comprising light-reflecting particles (10),
the light-reflecting particles (10) being chosen from a group formed by titanium oxide, aluminum oxide, halophosphates, calcium pyrophosphate, and strontium pyrophosphate, and
the light-reflecting particles (10) being surrounded by a skin layer (14) for improving the reflection of the coating (5).

2. A luminaire as claimed in claim 1, characterized in that the light-transmitting binder (11) comprises silicon oxide particles (20).

3. A luminaire as claimed in claim 2, characterized in that the size of the silicon oxide particles (20) ranges from 10 to 50 nm.

4. A luminaire as claimed in claim 1, characterized in that the inorganic sol-gel system is a silica-based sol-gel system.

5. A luminaire as claimed in claim 1, characterized in that the skin layer (14) comprises silicon oxide or aluminum oxide.

6. A luminaire as claimed in claim 1, characterized in that the size of the light-reflecting particles (10) ranges from 100 to 500 nm.

7. A luminaire as claimed in claim 1, characterized in that the thickness of the coating (5) ranges from 1 to 200 μm.

8. A luminaire as claimed in claim 7, characterized in that the thickness of the coating (5) ranges from 10 to 100 μm.

9. A luminaire as claimed in claim 1, characterized in that the reflecting portion (2) of the reflector body (9) comprises a metal.

10. A luminaire as claimed in claim 9, characterized in that the metal comprises aluminum.

11. A luminaire as claimed in claim 1, characterized in that the light-transmitting binder (11) comprises a stabilizing agent.
